(19) United States
(12) Patent Application Publication
(10) Pub. No.: US 2021/0144593 A1
(43) Pub. Date: May 13, 2021

(54) HANDOVER PERFORMING METHOD IN NON PUBLIC NETWORK

(71) Applicant: Electronics and Telecommunications Research Institute, Daejeon (KR)

(72) Inventor: Byungjun AHN, Daejeon (KR)

(73) Assignee: Electronics and Telecommunications Research Institute, Daejeon (KR)

(21) Appl. No.: 17/092,908

(22) Filed: Nov. 9, 2020

(30) Foreign Application Priority Data
Nov. 8, 2019 (KR) 10-2019-0142973
Nov. 9, 2020 (KR) 10-2020-0148557

(51) Int. Cl. H04W 36/00; H04W 36/14; H04W 36/38

(52) U.S. Cl. CPC H04W 36/0016; H04W 36/385; H04W 36/14

(57) ABSTRACT

A method of performing handover in a non-public network is disclosed. In the handover performing method, when the user equipment moves from the source cell for the source node of the NG-RAN to the target cell for the target node, the source node and the target node perform handover preparation procedures and handover resources for handover. Includes allocation procedures.

### CROSS-REFERENCE TO RELATED APPLICATION(S)

This application claims the priority benefit of Korean Patent Application No. 10-2019-0142973 filed on Nov. 08, 2019 and Korean Patent Application No. 10-2020-0148557 filed on Nov. 9, 2020 in the Korean Intellectual Property Office, the disclosures of which are incorporated herein by reference for all purposes.

### BACKGROUND

### 1. Field

One or more example embodiments relate to a handover performing method in non public network.

### 2. Description of Related Art

The user equipment may move from a cell covered by a source node to a cell covered by a target node. As the user equipment moves in this way, a handover is performed, and a procedure for providing data between the source node and the target node is required for the handover.

Currently, the 5G network is considering a handover procedure that does not take into account the non-public network, but when handover occurs in the non-public network, it is necessary to define a protocol between the source node, the target node, and the network devices of the 5G core network. have.

### SUMMARY

At least one example embodiment provides a handover performing method in non-public network.

At least one example embodiment also provides a procedure or information processed by a source node and a target node when a handover occurs for a user equipment located in a non-public network.

According to an aspect of at least one example embodiment, there is provided a handover performing method for the handover preparation procedure, the method comprising transmitting, by a source node of a NG-RAN, a handover request message to an Access and Mobility Management Function (AMF) device of the core network; receiving, by the source node of the NG-RAN, a handover command message from the AMF device, wherein the source node selects a target CAG (Closed Access Group) ID.

The source node knows the list of CAG IDs supported by candidate target cells which user equipment is able to move.

The source node selects same CAG ID currently accessed by the user equipment (UE) as the target CAG ID, wherein the same CAG ID ensures service continuity of the user equipment.

The source node transmits a Source to Target Transparent Container IE including the target CAG ID to the AMF device, wherein the Source to Target Transparent Container IE is a container information element transmitted from the source node of the NG-RAN to the target node related to the handover.

The source node selects the target CAG ID based on at least one of a preference of a CAG or a priority of a CAG for a user equipment moving to a target cell of the target node of the NG-RAN.

According to an aspect of at least one example embodiment, there is provided a handover performing method for the handover preparation procedure, the method comprising: receiving, by a target node of a NG-RAN, a handover request message from an Access and Mobility Management Function (AMF) device of a core network; transmitting, by the target node of the NG-RAN, a handover request acknowledge message to the AMF device, when a target CAG (Closed Access Group) ID included in a Source to Target Transparent Container IE transmitted to the AMF device is not supported by a target cell of the target node, wherein the target node selects one common CAG ID among CAG IDs supported by the user equipment and the target cell.

The target node transmits the handover request acknowledge message including the selected common CAG ID.

The target node selects one of common CAG IDs supported by the user equipment and the target cell based on preference information received from a source node of the NG-RAN.

The handover resource allocation procedure is performed by transmitting the handover request acknowledge message to the AMF device.

The Source to Target Transparent Container IE is a container information element transmitted from a source node of the NG-RAN to the target node related to the handover.

The target CAG ID included in the Source to Target Transparent Container IE is selected from a source node of the NG-RAN.

The target node use a Mobility Restriction List IE including at least one of a serving ID including a Public Land Mobile Network (PLMN) ID and a Network ID (NID) or a list of CAG IDs supported by a user equipment.

According to an aspect of at least one example embodiment, there is provided a handover performing method for the handover preparation procedure, the method comprising receiving, by a target node of the NG-RAN, a handover request message from an Access and Mobility Management Function (AMF) device of the core network; transmitting, by a target node of the NG-RAN, a handover failure message to the AMF device, wherein the target node transmits the handover failure message to the AMF device based on information included in the handover request message.

The target node rejects a handover resource allocation procedure based on information included in a mobility restriction list IE (Mobility Restriction List) IE included in the handover request message.

When a PLMN ID, MD, or a list of CAG IDs supported by the user equipment that is not supported by the target cell of the target node is included in the mobility restriction list IE, wherein the target node rejects the handover resource allocation procedure using the handover failure message.

The target node transmits Source to Target Transparent Container IE including target CAG (Closed Access Group) ID for handover resource allocation procedure to the AMF device.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates a diagram illustrating a handover procedure of a user equipment in a non-public network according to an embodiment of the present invention.

FIG. 2 illustrates a diagram illustrating a successful procedure of a handover preparation procedure according to an embodiment of the present invention.

FIG. 3 illustrates a diagram illustrating a failure procedure of a handover preparation procedure according to an embodiment of the present invention.

FIG. 4 illustrates a diagram illustrating a successful procedure of handover resource allocation according to an embodiment of the present invention.

FIG. 5 illustrates a diagram illustrating a procedure for failing handover resource allocation according to an embodiment of the present invention.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component. On the contrary, it should be noted that if it is described that one component is “directly connected,” “directly coupled,” or “directly joined” to another component, a third component may be absent. Expressions describing a relationship between components, for example, “between,” directly between,” or “directly neighboring,” etc., should be interpreted to be alike.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

FIG. 1 illustrates a diagram illustrating a handover procedure of a user equipment in a non-public network according to an embodiment of the present invention.

According to an embodiment of the present invention, a non-public network (NPN) is presented, which may correspond to a private 5G network. Non-public networks are classified into two types. One of the types of non-public networks is SNPN (Standalone NPN), and the other is PNI-NPN (Public Network Integrated Non-Public Network).

The NG-RAN may be shared with a plurality of SNPNs identified by a Public Land Mobile Network (PLMN) ID and a Network ID (MD). The NG-RAN may be shared with one or a plurality of SNPNs and one or a plurality of PLMNs. The NG-RAN may be shared with one or a plurality of PNI-NPNs having a CAG, and may be shared with one or a plurality of PLMNs. The NG-RAN may be shared with one or a plurality of PLMNs and one or a plurality of PNI-NPNs having a CAG (Closed Access Group).

PNI-NPNs are DNN(Data Network)s dedicated by PLMNs or NPNs formed by one or more network slice instances allocated for NPNs. When the PNI-NPN is formed through the PLMN, the user equipment 104 may have a subscription to the PLMN in order to access the PNI-NPN.

CAG (Closed Access Group) identifies a group of subscribers who are permitted to access one or more CAG cells associated with the CAG. CAG is used for PNI-NPN to prevent user equipment 104, which are not allowed to access the NPN through CAG cells associated with CAG, automatically select and access CAG cells.

The CAG is identified by a CAG ID that is unique within the scope of the PLMN ID. In addition, the CAG cell may broadcast one or more CAG IDs per PLMN.

To use the CAG, the user equipment 104 may be pre-configured or reconfigured with the following CAG information. CAG information may be included in a subscription as part of mobility restrictions. The CAG information is an allowed CAG list (e.g., a list of CAG IDs that the user equipment 104 may access) or a user equipment 104 that is allowed to access the 5G core network through a CAG cell. It may include a CAG-only indication indicating whether or not. The user equipment 104 may store the latest usable CAG information for every PLMN.

When a user equipment (UE) 104 is connected to a non-public network, a mobility restriction of the user equipment 104 may be set. When the user equipment 104 connects to the non-public network and moves from the first cell covered by the source node 101 to the second cell covered by the target node 102 in the non-public network, the user equipment 104 The target node 102 may determine whether to accept or reject the handover. Accordingly, the source node 101 needs to transmit information related to the NPN related to the user equipment 104 located in the cell covered by the source node 101 to the target node 102 when the handover proceeds.

If the user equipment 104 accesses the SNPN, the source node 101 may transmit a serving ID (PLMN ID and NID) to the target node 102 to the target node 102. And, when the user equipment 104 is connected to the PNI-NPN, the source node 101 is the CAG (Closed Access Group) ID to which the user equipment 104 is currently connected or the CAG preferred by the user equipment 104. Priority for may be transmitted to the target node 102. IF the source node 101 does not transmit the CAG ID (Closed Access Group) ID currently connected to the user equipment 104 or the priority of the CAG preferred by the user equipment 104 to the target node 102, If the target node 102 randomly selects a CAG to be handed over, continuity of the service to the user equipment 104 is not guaranteed.

Therefore, when the user equipment 104 is connected to the PNI-NPN, it is necessary to ensure service continuity for the user equipment 104 when performing handover to the user equipment 104. In this case, the source node 101 may select the target CAG ID based on at least one of the CAG ID of the PNI-NPN that the user equipment 104 is currently accessing, the CAG preferred by the user equipment 104, and the priority for the CAG.

Here, the target CAG ID may be used to identify a second cell that is a target cell related to the target node 102. In addition, the source node 101 transfers the target CAG ID selected in the handover preparation procedure or resource allocation procedure described in FIGS. 2 to 4 from the source node 101 to the target node 102 using Source to Target Transparent Container IE. The target CAG ID is selected from the source node 101, and the source node 101 may transmit the target CAG ID to the target node 102 by including the target CAG ID in the Source to Target Transparent Container IE.

Here, the transparent container from the source node 101 to the target node 102 means an information element related to information transparently transmitted from the source node 101 to the target node 102 when a handover is performed. do. At this time, if the target CAG ID selected by the source node 101 is not supported by the target node 102, the target node 102 select at least one of CAG ID supported by the target node 102 among CAG IDs accessible to the user equipment 104.

The target node 102 supports a plurality of target cells, but only one target cell among the plurality of target cells may be selected through a handover process. When handover to the selected target cell fails, a handover process is performed to another target cell associated with the target node 102.

As an example, the CAG ID included in the Source to Target Transparent Container IE is not supported by the target cell, the CAG ID transmitted from the source node 101 to the target node 102 is It may mean that it is not included in any of the target cells.

And, when the user equipment 104 is accessing the SNPN, the source node 101 is a mobility restriction list IE (Mobility Restriction List) including serving ID (PLMN ID and NID) in the handover preparation procedure and resource allocation procedure. IE) to the target node 102.

The CAG ID used in the present invention may mean an identifier used to support mobility of the user equipment 104 accessing the PNI-NPN. And, in the present invention considering the NPN, the user equipment 104 may select and access any one of a plurality of SNPNs or PNI-NPNs allowed to be accessed by the target node 102 when a handover is performed.

In the present invention, even if a handover occurs in the NPN, the source node 101 selects the target CAG ID and transmits the selected target CAG ID to the target node 102 in order to ensure the continuity of the service with respect to the user equipment 104. In addition, when the source node 101 transmits the target CAG ID to the target node 102, the target CAG ID may be included in the Source to Target Transparent Container IE and transmitted.

<SNPN>

When the user equipment 104 accesses the SNPN, the following conditions need to be satisfied.

Serving ID (PLMN ID, MD) displayed on the mobility restriction list

In mobility, the source node 101 of the NG-RAN may know (PLMN ID, NID) supported by a candidate target cell.

In mobility, the target node 102 of the NG-RAN needs to inform about the serving ID (PLMN ID, NID).

In mobility, if the serving ID (PLMN ID, MD) does not match the serving IDs (PLMN ID, NID) included in the support list of the target cell, the target RAN node may fail handover.

<PNI-NPN>

When the user equipment 104 accesses the PNI-NPN, the following conditions may need to be satisfied.

A list of CAG IDs for each PLMN supported by the user equipment 104 may be displayed in the mobility restriction list.

CAG-only indication for each PLMN (ie, prohibiting CAG UE from accessing non-CAG cells) may be displayed in the mobility restriction list.

In mobility, it is assumed that the source node 101 of the NG-RAN knows the CAG ID list supported by the candidate target cell.

If the CAG list allowed by the user equipment 104 in mobility does not match the CAG IDs supported by the target cell, the target node 102 of the NG-RAN may determine that the handover has failed. Here, it is assumed that the target cell is a CAG cell.

The source node 101 of the NG-RAN may know a list of CAG IDs supported by the target node 102 having a candidate target cell. In addition, when the target cell of the target node 102 supports the CAG ID to which the user equipment 104 is currently connected, the source node 101 may select the same CAG for CAG continuity. When the source node 101 of the NG-RAN selects the target CAG ID, the preference or priority of the CAG may also be considered. If the RAN node in the PNI-NPN may handle mobility using the mobility restriction list IE, the AMF device 103 of the core network does not need to recognize the serving CAG ID, but also the user equipment 104 There is no need to check the CAG ID list allowed by) and the CAG ID supported by the target node 102. The target CAG ID selected by the source node 101 may be included in the Source to Target Transparent Container IE.

According to an embodiment of the present invention, the source node 101 of the NG-RAN may select a target CAG ID using the Source to Target Transparent Container IE and signal the target CAG ID to the target cell of the target node 102. have.

In the case of SNPN mobility, connected mode mobility between two SNPNs may not be allowed. Accordingly, when serving ID (PLMN ID, NID) information is added to the mobility restriction list IE, the target node 102 of the NG-RAN may determine that the handover request is accepted. Therefore, in the handover preparation procedure, it is not necessary to include the selected target ID PLMN ID and NID in the Target ID IE of the handover request message (HANDOVER REQUIRED).

Except for the Mobility Restriction List IE, if connection mode movement between two SNPNs is not allowed, a serving ID (PLMN ID, NID) for the target node 102 of the NG-RAN needs to be added. none.

When the target CAG ID included in the Source to Target Transparent Container IE is not supported by the target cell of the target node 102, the target node 102 of the NG-RAN select one of CAG IDs commonly supported by the user equipment 104 and the target cell. The target CAG ID selected by the target node 102 may be included in a handover request confirmation message (HANDOVER REQUEST ACKNOWLEDGE). The target node 102 may select one of the common CAG IDs based on the preference information of the user equipment 104 transmitted by the source node 101 to the target node 102. As an example, the preference information may be set by the user equipment 104 for reasons such as charges or by a mobile communication service provider in consideration of network congestion.

According to an embodiment of the present invention, if, if the target node 102 of the NG-RAN receives a handover request message (HANDOVER REQUEST) including the mobility restriction list IE, serving ID PLMN ID, NID or user equipment If the CAG ID list of 104 is not supported in the target cell, the target node 102 of the NG-RAN may reject the handover procedure using a handover failure message (HANDOVER FAILURE).

According to an embodiment of the present invention, when the target CAG ID included in the Source to Target Transparent Container IE is not supported by the target cell, the target node 102 of the NG-RAN select a common CAG ID supported by both the UE and the target cell.

According to the above, the handover performing method according to an embodiment of the present invention may handle the following procedures.

(1) The source node 101 of the NG-RAN may select a target CAG ID using the Source to Target Transparent Container IE and signal the target cell.

(2) Mobility Restriction List Assuming that connection mode movement between two SNPNs other than IE is not allowed, there is no need to add a serving ID (PLMN ID, MD) to the target node 102 of the NG-RAN.

(3) If the target CAG ID included in the Source to Target Transparent Container IE is not supported in the target cell, the target node 102 of the NG-RAN may selects one of the common CAG IDs supported by both the user equipment 104 and the target cell.

FIG. 2 illustrates a diagram illustrating a successful procedure of a handover preparation procedure according to an embodiment of the present invention.

The handover preparation procedure may mean that the target node requests resource preparation from the side through the 5G core network. For a specific user equipment, there may be only one preparation procedure for handover that proceeds simultaneously.

<Successful Aaction>

The source node of the NG-RAN may transmit a handover request message (HANDOVER REQUIRED) to the serving AMF device 202 to start handover preparation. When the source node 201 of the NG-RAN sends a handover request message message to the AMF device 202, it is necessary to start the TNGRELOCprep timer. The source node of the NG-RAN needs to indicate an appropriate cause value for handover in the Cause IE.

The target CAG ID may also be included in the Source to Target Transparent Container IE of the handover request message transmitted from the source node 201 to the AMF device 202 in the handover preparation procedure and transmitted.

When the AMF device 202 receives the handover request message transmitted by the source node 201 of the NG-RAN, the AMF device 202 sends a Handover Required Transfer IE for each PDU session indicated in the PDU Session ID IE. It is necessary to transmit transparently to the SMF device related to the session.

In the case of intra-system handover, the information included in the Source to Target Transparent Container IE is encoded by the source node 201 of the NG-RAN according to the definition of the Transparent Container IE of the target node of the NG-RAN.

When the DL Forwarding IE is included for the QoS flow given in the PDU Session Resource Information Item IE in the Source to Target Transparent Container IE included in the handover request message, and the DL Forwarding IE is set to “DL forwarding proposed”, it is a QoS flow. For this, it may mean that the source node 201 of the NG-RAN proposes forwarding of downlink data.

When the DRBs to QoS Flows Mapping List IE is included in the PDU Session Resource Information Item IE in the Source to Target Transparent Container IE included in the handover request message, it is the source node 201 of the NG-RAN to the DRB. This could mean that the data suggests forwarding.

If the DRBs to QoS Flows Mapping List IE in the Source to Target Transparent Container IE included in the handover request message contains the QoS Flow Mapping Indication IE for the QoS flow included in the Associated QoS Flow List IE, it is NG-RAN. This may mean that the source node 201 of is mapping the uplink or downlink of the QoS flow to the DRB.

If the handover command message includes a DL Forwarding UP TNL Information IE for a given DRB in the Handover Command Transfer IE, the source node 201 of the NG-RAN is a downlink for the DRB by the target node of the NG-RAN. You may consider accepting the forwarding of the data. If the handover command message includes the UL Forwarding UP TNL Information IE for the DRB given in the Data Forwarding Response DRB List IE in the Handover Command Transfer IE, it means that the target node of the NG-RAN forwards the uplink data to the DRB.

The source node 201 of the NG-RAN may select a target CAG ID. The source node 201 of the NG-RAN may select the same CAG ID to which the user equipment is currently connected. The target CAG ID selected by the source node 201 of the NG-RAN may be included in the Source to Target Transparent Container IE.

In the case of handover of the inter system to LTE, the information of the Source to Target Transparent Container IE needs to be encoded according to the definition of the Source eNB to Target eNB Transparent Container IE.

If the Direct Forwarding Path Availability IE is included in the handover request message, the AMF device may process the Direct Forwarding Path Availability IE. If the Direct Forwarding Path Availability IE is included in the Handover Required Transfer IE of the handover request message, the SMF device may process the Direct Forwarding Path Availability IE.

When the target node is ready for handover including resource reservation, the AMF device 202 may respond to the source node 201 of the NG-RAN with a handover command message (HANDOVER COMMAND). When the AMF device 202 receives a handover command message from the source node 201 of the NG-RAN, the source node 201 of the NG-RAN needs to stop the TNG_{RELOCprep} timer and start the TNG_{RELOCoverall} timer.

If there is a PDU session that is not allowed in the target node, the PDU session needs to be displayed in the PDU Session Resources to Release List IE.

When the handover command message includes the QoS Flow to be Forwarded List IE in the Handover Command Transfer IE for a given PDU session, the source node 201 of the NG-RAN is listed through the forwarding tunnel specified in the DL Forwarding UP TNL Information IE. Data forwarding mayn be started for the established QoS flow.

When the handover command message includes the Additional DL Forwarding UP TNL Information IE in the Handover Command Transfer IE, the source node 201 of the NG-RAN starts data forwarding of a PDU session separated from another tunnel, and is associated with data forwarding. UP transport layer information may be used for the forwarding QoS flow.

When the AMF device 202 receives the Target to Source Transparent Container IE from the target node for handover, the Target to Source Transparent Container IE needs to be included in the handover command message.

In the case of inter-system handover to LTE, the Target to Source Transparent Container IE needs to be encoded according to the definition of the Target eNB to Source eNB Transparent Container IE.

<Interaction with Other NGAP Procedures>

After the handover request message is transmitted from the source node 201 to the AMF device 202, before the handover preparation procedure ends, the source node 201 of the NG-RAN is AMF initiated PDU Session in the same UE-related signaling connection. When receiving a management procedure, the source node 201 of the NG-RAN needs to perform one of the following procedures.

1. By performing a handover cancellation procedure having an appropriate cause value, the handover preparation procedure may be canceled. After the handover cancellation procedure is successfully completed, the source node 201 of the NG-RAN may start the AMF initiated PDU Session Management procedure.

2. The AMF initiated PDU Session Management procedure is terminated by transmitting a response message having an appropriate cause value such as “NG intra-system handover triggered” or “NG inter-system handover triggered” to the AMF device 202. Thereafter, the source node 201 of the NG-RAN may continue the handover procedure.

FIG. 3 illustrates a diagram illustrating a failure procedure of a handover preparation procedure according to an embodiment of the present invention.

For the handover preparation procedure, the source node 301 of the NG-RAN may transmit a handover request message to the AMF device 302. If the 5G core network or the target node cannot accept the PDU session resource or a failure occurs during the handover preparation procedure, the AMF device 302 sends a handover preparation failure message including an appropriate cause value to the NG-RAN. It may be transmitted to the source node 301.

<Interaction with the Handover Cancellation Procedure>

If the response to the handover request message from the AMF device 302 is not delivered before the timer TNG_{RELOCprep} expires in the source node 301 of the NG-RAN, the source node 301 of the NG-RAN is appropriate for the Cause IE. The handover preparation procedure may be canceled by starting the handover cancellation procedure having a value. The source node 301 of the NG-RAN may ignore all handover command messages or handover preparation failure messages received after the handover cancellation procedure is started.

FIG. 4 illustrates a diagram illustrating a successful procedure of handover resource allocation according to an embodiment of the present invention.

<Handover Resource Allocation>

The handover resource allocation procedure means that the target node of the NG-RAN reserves resources for handover of the user equipment.

<Successful Action>

The AMF device 402 may start the handover resource allocation procedure by transmitting a handover request message (HANDOVER REQUEST) to the target node 401 of the NG-RAN.

When the Masked IMEISV IE is included in the handover request message, the target node 401 of the NG-RAN may use the Masked IMEISV IE to determine the characteristics of the user equipment for subsequent processing.

When the target node 401 of the NG-RAN receives the handover request message from the AMF device 402, the target node 401 may perform the following procedure.

(i) The target node 401 may attempt to implement PDU session configuration and related security.

(ii) The target node 401 may store the UE Aggregate Maximum Bit Rate in the UE context, and use the UE Aggregate Maximum Bit Rate for all Non-GBR QoS flows for the user equipment.

(iii) The target node 401 may store the mobility restriction list in the UE context.

(iv) The target node 401 may store the security capability of the user equipment in the UE context.

(v) The target node 401 may store the security context in the UE context and use the security context.

When the target node 401 of the NG-RAN receives the UE History Information IE included in the Source to Target Transparent Container IE of the handover request message, the target node 401 of the NG-RAN collects information defined as mandatory infomation in the UE History Information IE. And, the target node 401 may collect information defined as optional information defined in the UE History Information IE while the user equipment is located in any one of the cells of the target node 401, and uses it in a future handover preparation procedure.

When the target node 401 receives the PDU Session Resource Setup List IE included in the handover request message, the target node 401 of the NG-RAN may operate the same as defined in the PDU Session Resource Setup procedure. The target node 401 of the NG-RAN may transmit a handover request acknowledgment message (HANDOVER REQUEST ACKNOWLEDGE) including a result of each PDU session resource requested to be set up to the AMF device 402. In particular, in order to successfully set up each PDU session resource, the handover request confirmation message may include a Handover Request Acknowledge Transfer IE including the following information.

(i) QoS Flow Setup Response List List of QoS flows successfully established in IE.

(ii) When data forwarding for QoS flow is approved, Data Forwarding Accepted IE

(iii) QoS Flow Failed to Setup List List of QoS flows that could not be set in IE

(iv) UP transport layer information to be used for PDU session

(v) Security results related to PDU session

For each PDU session resource that fails to set up, a Handover Resource Allocation Unsuccessful Transfer IE containing a cause value that must be accurate enough to know the reason for the unsuccessful establishment of the SMF device needs to be included in the handover request confirmation message. There is.

When the AMF device 402 receives a handover request acknowledgment message (HANDOVER REQUEST ACKNOWLEDGE) from the target node 401, the AMF device 402 receives the Handover Request Acknowledge Transfer IE or Handover for each PDU session indicated in the PDU Session ID IE. Resource Allocation Unsuccessful Transfer IE may be transparently transmitted to the SMF device related to the corresponding PDU session.

If the Data Forwarding Not Possible IE related to the given PDU session in the Handover Request Transfer IE is set to “data forwarding not possible” and the handover request message includes the Data Forwarding Not Possible IE, the target node of the NG-RAN (401) may not include the Data Forwarding Response DRB List IE in the Handover Request Acknowledge Transfer IE in the handover request confirmation message for the corresponding PDU session for the DL Forwarding UP TNL Information IE and intra system handover.

In the case of intra system handover, when the target node 401 of the NG-RAN accepts downlink data delivery for at least one QoS flow set to “DL forwarding suggest” in the DL Forwarding IE, DL Forwarding UP TNL Information is included. The IE of the Handover Request Acknowledge Transfer IE may check the IE as a forwarding tunnel for the QoS flows listed in the QoS flow configuration response list IE of the HANDOVER REQUEST ACKNOWLEDGE message.

In the case of intra system handover, if the target node of the NG-RAN accepts uplink data forwarding for the QoS flow for the UL Forwarding IE set as “UL forwarding suggest”, ( ) is the PDU Session of the handover request confirmation message. The Handover Request Acknowledge Transfer IE for the PDU session in the Resource Admitted List IE may include UL Forwarding UP TNL Information.

In the case of intra system handover, if the additional DL UP TNL Information for the HO List IE included in the Handover Request Acknowledge Transfer IE of the handover request acknowledgment message is included for each PDU session, the SMF device may consider the Additional DL NG-U Consider UP TNL Information as a downlink end point for the associated flow indicated by the Additional QoS Flow Setup Response List IE for a PDU session separated from another tunnel, and the Additional DL Forwarding UP TNL Information IE as a forward tunnel associated with the QoS flow.

In the case of intra system handover, if the target node of the NG-RAN accepts data forwarding for a successfully configured DRB, the target node 401 of the NG-RAN is the Handover Request Acknowledge Transfer IE of the handover request confirmation message. In the Data Forwarding Response DRB List IE, a DL Forwarding UP TNL Information IE for DRB may be included.

If the handover request acknowledgment message includes the UL Forwarding UP TNL Information IE for the DRB given in the Data Forwarding Response DRB List IE in the Handover Request Acknowledge Transfer IE, it is the target node of the NG-RAN to transmit the uplink data for the DRB.

In the case of inter-system handover from E-UTRAN, the target node of NG-RAN is (i) DL Forwarding IE is set to “DL forwarding proposed” for the corresponding E-RAB in Source to Target Transparent Container IE, (ii) The target node of the NG-RAN may include a Data Forwarding Accepted IE for each QoS flow that approves the proposed forwarding of downlink data for the QoS flow.

If the target node 401 of the NG-RAN approves downlink data forwarding for at least one QoS flow of the approved PDU session, for a PDU session in the PDU Session Resources Admitted List IE of the handover request confirmation message This may mean including the DL Forwarding UP TNL Information IE in the PDU Session Resource Setup Response Transfer IE.

The target node of the NG-RAN may use information such as a serving ID (PLMN ID, NID) or CAG IDs supported by the user equipment in the Mobility Restriction List IE of the handover request message for the following purposes.

(i) Determining a target for a subsequent mobility action in order to provide information on a target of a mobility action directed to a user equipment by a target node of the NG-RAN

(ii) Selecting an appropriate SCG (Secondary Cell Group) during dual connection operation

(iii) Allocating an appropriate RNA(s) (radio access network (RAN) based notification area) to the user equipment when moving the user equipment to the RRC INACTIVE state.

If the handover request message does not include the Mobility Restriction List IE, the target node of the NG-RAN may consider not to apply roaming and access restrictions to the user equipment. In addition, when any one of the QoS flows includes a special Allocation/Retention Priority (ARP) value, the target node of the NG-RAN may consider not to apply roaming and access restrictions to the user equipment.

If the handover request message includes the Trace Activation IE, the target node 401 of the NG-RAN may start the requested trace function.

If the handover request message includes the Location Reporting Request Type IE, the target node 401 of the NG-RAN may perform a location reporting function requested for the user equipment.

When the handover request message includes Core Network Assistance Information for RRC INACTIVE IE, the target node of NG-RAN stores Core Network Assistance information in the UE context, and if the user equipment is in RRC_INACTIVE state, Core Network Assistance Information may be used for RNA configuration and RAN paging.

If the handover request message includes the CN Assisted RAN Parameters Tuning IE, the target node of the NG-RAN may use the CN Assisted RAN Parameters Tuning IE.

If the handover request message includes the New Security Context Indicator IE, the target node of the NG-RAN may use the New Security Context Indicator IE.

If the NASC IE is included in the handover request message, the target node of the NG-RAN may use the NASC IE toward the user equipment.

If the handover request message includes the RRC Inactive Transition Report Request IE, the target node of the NG-RAN may store the RRC Inactive Transition Report Request IE in the UE context.

If the handover request message contains a redirection to the Voice EPS Fallback IE, the target node of the NG-RAN may store the Voice EPS Fallback IE and use the Voice EPS Fallback IE in a subsequent determination of the EPS fallback of the voice. .

After all necessary resources have been allocated for the allowed PDU session resources, the target node of the NG-RAN may generate a handover request confirmation message.

When the target CAG ID included in the Source to Target Transparent Container IE is not supported by the target cell of the target node 401, the target node 401 of the NG-RAN may select a common CAG ID supported by both the user equipment and the target cell. The target CAG ID selected by the target node 401 may be included in the handover request confirmation message.

FIG. 5 illustrates a diagram illustrating a procedure for failing handover resource allocation according to an embodiment of the present invention.

<Failed Action>

When the target node 501 of the NG-RAN does not allow the PDU session resource or a failure occurs during the handover preparation procedure, the target node sends a handover failure message having an appropriate cause value to the AMF device 502.

When the target node 501 of the NG-RAN receives a handover request message that does not include the Mobility Restriction List IE, and the serving PLMN may not be determined by the target node of the NG-RAN, the target node 501 of the NG-RAN May reject the handover resource allocation procedure using the handover failure message.

The target node 501 of the NG-RAN receives the handover request message including the Mobility Restriction List IE from the AMF device 502, and the serving ID (PLMN ID, NID) or the user equipment by the target cell of the target node If the CAG ID list is not supported, the target node of the NG-RAN may reject the handover resource allocation procedure using a handover failure message.

Terms described in the present invention may be defined as follows.

(1) Handover request confirmation message (HANDOVER REQUEST ACKNOWLEDGE)

The handover request confirmation message is a message for the target node 401 of the NG-RAN to notify the AMF device 402 about resource allocation for handover. The handover request confirmation message is transmitted from the target node 401 of the NG-RAN to the AMF device 402, and may include a target CAG ID selected by the target node. Here, the target CAG ID may mean one CAG ID selected by the target node from among common CAG IDs supported by both the user equipment and the target cell of the target node 401.

The HANDOVER REQUEST ACKNOWLEDGE message may include IEs of Table 1 below.

TABLE 1

| | | | Semantics | | Assigned |
|---|---|---|---|---|---|
| IE/Group Name | Presence | Range | description | Criticality | Criticality |
| Message Type | M | | | YES | reject |
| AMF UE NGAP ID | M | | | YES | ignore |
| RAN UE NGAP ID | M | | Allocated at the | YES | ignore |
| | | | target NG-RAN | | |
| | | | node. | | |
| PDU Session | | 1 | | YES | ignore |
| Resource | | | | | |
| Admitted List | | | | | |
| >PDU Session | | 1.. <maxno | | — | |
| Resource | | ofPDU | | | |
| Admitted Item | | Sessions> | | | |
| >>PDU Session | M | | | — | |
| ID | | | | | |
| >>Handover | M | | Containing the | — | |
| Request | | | Handover Request | | |
| Acknowledge | | | Acknowledge | | |
| Transfer | | | Transfer IE | | |
| PDU Session | | 0..1 | | YES | ignore |
| Resource Failed to | | | | | |
| Setup List | | | | | |
| >PDU Session | | 1.. <maxno | | — | |
| Resource Failed | | ofPDU | | | |
| to Setup Item | | Sessions> | | | |
| >>PDU Session | M | | | — | |
| ID | | | | | |
| >>Handover | M | | Containing the | — | |
| Resource | | | Handover Resource | | |
| Allocation | | | Allocation | | |
| Unsuccessful | | | Unsuccessful | | |
| Transfer | | | Transfer | | |
| Target to Source | M | | | YES | reject |
| Transparent | | | | | |
| Container | | | | | |
| Criticality | O | | | YES | ignore |
| Diagnostics | | | | | |
| Selected Target | O | | | YES | ignore |
| CAG ID | | | | | |

(2) Target ID

The target ID means an IE for identifying a target node for handover. The target ID may include the IE of Table 2 below.

TABLE 2

| IE/Group Name | Presence | Range | Semantics description |
|---|---|---|---|
| CHOICE Target ID | M | | |
| >NG-RAN | | | |
| >>Global RAN | M | | |
| Node ID | | | |
| >>Selected TAI | M | | |
| >>Serving NID | O | | |
| >E-UTRAN | | | |
| >>Global eNB ID | M | | |
| >>Selected EPS TAI | M | | |

(3) Source to Target Transparent Container IE

The Source to Target Transparent Container IE may be generated by the source node of the NG-RAN and then transmitted from the source node to the target node. In the case of inter-system handover to 5G, the Source to Target Transparent Container IE may be transmitted from an external handover source to the target node of the NG-RAN.

Source to Target Transparent Container IE may include the IE of Table 3 below.

TABLE 3

| | | | Semantics | | Assigned |
|---|---|---|---|---|---|
| IE/Group Name | Presence | Range | description | Criticality | Criticality |
| RRC Container | M | | Includes the RRC | — | |
| | | | HandoverPreparation | | |
| | | | Information | | |
| | | | message if the | | |
| | | | target is a gNB. | | |
| | | | Includes the RRC | | |
| | | | HandoverPreparation | | |
| | | | Information | | |
| | | | message if the | | |
| | | | target is an | | |
| | | | ng-eNB. | | |
| PDU Session | | 0..1 | For intra-system | — | |
| Resource | | | handovers in | | |
| Information List | | | NG-RAN. | | |
| >PDU Session | | 1..<max | | — | |
| Resource | | noofPDU | | | |
| Information Item | | Sessions> | | | |
| >>PDU Session | M | | | — | |
| ID | | | | | |
| >>QoS Flow | | 1 | | — | |
| Information List | | | | | |
| >>>QoS Flow | | 1..<max | | — | |
| Information | | noofQoS | | | |
| Item | | Flows> | | | |
| >>>>QoS Flow | M | | | — | |
| Identifier | | | | | |
| >>>>DL | O | | | — | |
| Forwarding | | | | | |
| >>>>UL | O | | | YES | reject |
| Forwarding | | | | | |
| >>DRBs to QoS | O | | | — | |
| Flows Mapping | | | | | |
| List | | | | | |
| E-RAB | | 0..1 | For inter-system | — | |
| Information List | | | handovers to 5G. | | |
| >E-RAB | | 1..<max | | — | |
| Information Item | | noofE- | | | |
| | | RABs> | | | |
| >>E-RAB ID | M | | | — | |
| >>DL | O | | | — | |
| Forwarding | | | | | |
| Target Cell ID | M | | | — | |
| Index to | O | | | — | |
| RAT/Frequency | | | | | |
| Selection Priority | | | | | |
| UE History | M | | | — | |
| Information | | | | | |
| Target CAG ID | O | | Selected target | | |
| | | | CAG ID at the | | |
| | | | source NG-RAN | | |
| | | | node | | |

(4) Mobility Restriction List

Mobility Restriction List IE may define roaming in the NG-RAN for a subsequent mobility operation (e.g., during a handover or dual connection operation, or SCG selection for appropriate RNA allocation) performed at the target of the mobility action of the user equipment or access restrictions. The Mobility Restriction List may include IEs of Table 4 below.

TABLE 4

| | | | Semantics | | Assigned |
|---|---|---|---|---|---|
| IE/Group Name | Presence | Range | description | Criticality | Criticality |
| Serving PLMN | M | | | — | |
| Equivalent | | 0..<max | Allowed PLMNs in | — | |
| PLMNs | | noof | addition to Serving | | |
| | | EPLMNs> | PLMN. | | |
| | | | This list | | |
| | | | corresponds to the | | |
| | | | list of “equivalent | | |
| | | | PLMNs” This list is | | |
| | | | part of the roaming | | |
| | | | restriction | | |
| | | | information. | | |
| | | | Roaming | | |
| | | | restrictions apply to | | |
| | | | PLMNs other than | | |
| | | | the Serving PLMN | | |
| | | | and Equivalent | | |
| | | | PLMNs. | | |
| >PLMN Identity | M | | | — | |
| RAT Restrictions | | 0..<max | This IE contains | — | |
| | | noof | RAT restriction | | |
| | | EPLMNs | related information | | |
| | | PlusOne> | | | |
| >PLMN Identity | M | | | — | |
| >RAT Restriction | M | | Each position in the | — | |
| Information | | | bitmap represents a | | |
| | | | RAT. | | |
| | | | If a bit is set to “1”, | | |
| | | | the respective RAT | | |
| | | | is restricted for the | | |
| | | | UE. | | |
| | | | If a bit is set to “0”, | | |
| | | | the respective RAT | | |
| | | | is not restricted for | | |
| | | | the UE. | | |
| | | | Bits 2-7 reserved | | |
| | | | for future use. | | |
| Forbidden Area | | 0..<max | This IE contains | — | |
| Information | | noof | Forbidden Area | | |
| | | EPLMNs | information | | |
| | | PlusOne> | | | |
| >PLMN Identity | M | | | — | |
| >Forbidden | | 1..<max | | — | |
| TACs | | noof | | | |
| | | ForbTACs> | | | |
| >>TAC | M | | The TAC of the | — | |
| | | | forbidden TAI. | | |
| Service Area | | 0..<max | This IE contains | — | |
| Information | | noof | Service Area | | |
| | | EPLMNs | Restriction | | |
| | | PlusOne> | information | | |
| >PLMN Identity | M | | | — | |
| >Allowed TACs | | 0..<max | | — | |
| | | noof | | | |
| | | Allowed | | | |
| | | Areas> | | | |
| >>TAC | M | | The TAC of the | — | |
| | | | allowed TAI. | | |
| >Not Allowed | | 0..<max | | — | |
| TACs | | noof | | | |
| | | Allowed | | | |
| | | Areas> | | | |
| >>TAC | M | | The TAC of the | — | |
| | | | not-allowed TAI. | | |
| Last E-UTRAN | O | | Indicates the | YES | ignore |
| PLMN Identity | | | E-UTRAN PLMN | | |
| | | | ID from where the | | |
| | | | UE formerly | | |
| | | | handed over to 5GS | | |
| | | | and which is | | |
| | | | preferred in case of | | |
| | | | subsequent mobility | | |
| | | | to EPS. | | |
| Core Network | O | | Indicates whether | YES | ignore |
| Type Restriction | | | the UE is restricted | | |
| for Serving PLMN | | | to connect to EPC | | |
| | | | for the Serving | | |
| | | | PLMN | | |
| Core Network | | 0..<max | | YES | ignore |
| Type Restriction | | noof | | | |
| for Equivalent | | EPLMNs> | | | |
| PLMNs | | | | | |
| >PLMN Identity | M | | Includes any of the | — | |
| | | | Equivalent PLMNs | | |
| | | | listed in the | | |
| | | | Mobility Restriction | | |
| | | | List IE for which | | |
| | | | CN Type restriction | | |
| | | | applies | | |
| >Core Network | M | | Indicates whether | | |
| Type Restriction | | | the UE is restricted | | |
| | | | to connect to EPC | | |
| | | | or to 5GC for this | | |
| | | | PLMN. | | |
| Serving NID | O | | | | |
| UE supported | | | List of CAG IDs | | |
| CAG IDs | | | allowed for the UE | | |
| | | | access per PLMN | | |
| >UE supported | | | | | |
| CAG IDs Item | | | | | |
| >>PLMN Identity | M | | | | |
| >>CAG | O | | | | |
| restriction | | | | | |
| >>CAG ID List | | | | | |
| per PLMN | | | | | |
| >>> CAG ID List | | 1..<max | | | |
| per PLMN Item | | noof | | | |
| | | CAGsper | | | |
| | | PLMN> | | | |
| >>>> CAG ID | | | | | |

(5) CAG ID

CAG ID is an ID that identifies CAG for each PLMN. The CAG ID may include IEs of Table 5 below.

TABLE 5

| IE/Group | | | IE type and | Semantics |
|---|---|---|---|---|
| Name | Presence | Range | reference | description |
| CAG ID | M | | BIT STRING | |
| | | | (SIZE (FFS)) | |

(6) serving NID

The serving NID may identify SNPNs for each PLMN. The serving NID may include IEs in Table 6 below.

TABLE 6

| IE/Group | | | IE type and | Semantics |
|---|---|---|---|---|
| Name | Presence | Range | reference | description |
| NID | M | | BIT STRING | |
| | | | (SIZE (FFS)) | |

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

The units and/or modules described herein may be implemented using hardware components, software components, and/or combination thereof. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include a plurality of processing elements and a plurality of types of processing elements. For example, a processing device may include a plurality of processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A handover performing method for the handover preparation procedure, the method comprising:
transmitting, by a source node of a NG-RAN, a handover request message to an Access and Mobility Management Function (AMF) device of the core network;
receiving, by the source node of the NG-RAN, a handover command message from the AMF device,
wherein the source node selects a target CAG (Closed Access Group) ID.

2. The method of claim 1, wherein the source node knows the list of CAG IDs supported by candidate target cells which user equipment is able to move.

3. The method of claim 1, wherein the source node selects same CAG ID currently accessed by the user equipment (UE) as the target CAG ID,
wherein the same CAG ID ensures service continuity of the user equipment.

4. The method of claim 1, wherein the source node transmits a Source to Target Transparent Container IE including the target CAG ID to the AMF device,
wherein the Source to Target Transparent Container IE is a container information element transmitted from the source node of the NG-RAN to the target node related to the handover.

5. The method of claim 1, wherein the source node selects the target CAG ID based on at least one of a preference of a CAG or a priority of a CAG for a user equipment moving to a target cell of the target node of the NG-RAN.

6. A handover performing method for the handover preparation procedure, the method comprising:
receiving, by a target node of a NG-RAN, a handover request message from an Access and Mobility Management Function (AMF) device of a core network;
transmitting, by the target node of the NG-RAN, a handover request acknowledge message to the AMF device,
when a target CAG (Closed Access Group) ID included in a Source to Target Transparent Container IE transmitted to the AMF device is not supported by a target cell of the target node, wherein the target node selects one common CAG ID among CAG IDs supported by the user equipment and the target cell.

7. The method of claim 6, wherein the target node transmits the handover request acknowledge message including the selected common CAG ID.

8. The method of claim 6, wherein the target node selects one of common CAG IDs supported by the user equipment and the target cell based on preference information received from a source node of the NG-RAN.

9. The method of claim 6, wherein the handover resource allocation procedure is performed by transmitting the handover request acknowledge message to the AMF device.

10. The method of claim 6, wherein the Source to Target Transparent Container IE is a container information element transmitted from a source node of the NG-RAN to the target node related to the handover.

11. The method of claim 6, wherein the target CAG ID included in the Source to Target Transparent Container IE is selected from a source node of the NG-RAN.

12. The method of claim 6, wherein the target node use a Mobility Restriction List IE including at least one of a serving ID including a Public Land Mobile Network (PLMN) ID and a Network ID (MD) or a list of CAG IDs supported by a user equipment.

13. A handover performing method for the handover preparation procedure, the method comprising:
receiving, by a target node of the NG-RAN, a handover request message from an Access and Mobility Management Function (AMF) device of the core network;
transmitting, by a target node of the NG-RAN, a handover failure message to the AMF device,
wherein the target node transmits the handover failure message to the AMF device based on information included in the handover request message.

14. The method of claim 13, wherein the target node rejects a handover resource allocation procedure based on information included in a mobility restriction list IE (Mobility Restriction List) IE included in the handover request message.

15. The method of claim 13, when a PLMN ID, MD, or a list of CAG IDs supported by the user equipment that is not supported by the target cell of the target node is included in the mobility restriction list IE, wherein the target node rejects the handover resource allocation procedure using the handover failure message.

16. The method of claim 13, wherein the target node transmits Source to Target Transparent Container IE including target CAG (Closed Access Group) ID for handover resource allocation procedure to the AMF device.
